(19) United States
(12) Patent Application Publication
(10) Pub. No.: US 2003/0048036 A1
(43) Pub. Date: Mar. 13, 2003

(54) MEMS comb-finger actuator

(76) Inventor: Mark Alan Lemkin, El Cerrito, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 09/944,395

(22) Filed: Aug. 31, 2001

(51) Int. Cl. G21H 1/00

(52) U.S. Cl. 310/309; 310/301

(57) ABSTRACT

A comb-finger microstructure is disclosed for use in optical switching arrays, beam steering, optical displays, disk drive head actuators and the like. The microstructure is capable of producing linear or nonlinear actuation forces, perpendicular to the surface of a chip in which the microactuator is formed, as a function of applied voltages. The microstructure further provides the ability to detect the position of a movable structure with respect to a stationary or anchored structure.

### CROSS REFERENCE TO RELATED DOCUMENT

The present application is related to Disclosure Document No. 482,278, entitled, “Comb-Finger Actuator,” filed in the U.S. patent and Trademark Office on Nov. 7, 2000, which Disclosure Document is incorporated by reference herein in its entirety.

### BACKGROUND OF THE INVENTION

1. Field of the Invention

This invention relates generally to the field of microelectromechanical systems (MEMS), and in particular to an electrostatic comb-finger microactuator and microsensor for use in optical switching arrays, beam steering, optical displays, disk drive head actuators and other micromechanical applications.

2. Description of the Related Art

MEMS devices offer significant advantages over conventional electromechanical systems with respect to their application, size, power consumption and cost of manufacture. Moreover, leveraging off of the significant progress over the past two decades in the manufacture of integrated circuits on silicon substrates, MEMS devices may be batch processed and packaged together with other IC devices using standard integrated processing techniques and with minimal additional processing steps.

While MEMS devices may be micromachined according to a variety of methodologies, typically a MEMS device is formed by applying a thin film layer on a substrate, covering the film with a layer of photoresist, masking the photoresist in the pattern of the desired device features for that layer, and then etching away the undesired portions of the thin film layer. This deposition and photolithographic definition process may be repeated to apply successive etched thin film layers on the substrate until the micromechanical device is formed. A final release etching step is typically performed which removes material from within and around the micromechanical device to release the device so that it can perform its mechanical function. Electrical connections are often also made to the device to allow controlled movement of, or sensing through, the device. The materials from which the layers are formed are selected to control the mechanical, electrical and/or chemical response of the layer and overall device.

Variable capacitors are often used in MEMS, for electrostatic actuation (in which an applied voltage or charge effects a force between two or more plates) or inferring position (in which the relationship between charge and voltage is used to infer the gap between two or more plates comprising the capacitor). In general, such capacitors may be used for either effecting a force or detecting absolute or relative position between one or more plates.

A parallel-plate capacitor configured as an electrostatic actuator is represented schematically in FIG. 1 and in the circuit diagram of FIG. 2. In such devices, a pair of spaced-apart plates or electrodes 20 are formed on the substrate 22, with one being stationary and the other being cantilevered, connected to the substrate via a compliant suspension, or otherwise free to move toward and away from the fixed plate. As such, parallel plate microactuators are used to achieve motion in a plane perpendicular to the chip on which the device is formed. Although the device may also be connected as a sensing element, when the device is constructed as an actuator, a known voltage potential V is applied across the electrodes 20, which voltage generates an electrostatic attractive force Fₑ between the electrodes. Depending on the mechanical stiffness of the flexible electrode and the electrostatic force generated across the electrodes, the flexible electrode moves a fixed distance toward the stationary electrode to accomplish some associated mechanical actuation.

Quantitatively, the force Fₘ generated by the mechanical stiffness in the flexible electrode 20 is given by Hookes law:

Fₘ=−kz

where k is the mechanical spring constant of the flexible electrode and z is the distance the electrode moves under the applied voltage. The electrostatic force Fₑ is given by the relationship:

$${F}_{e} = \frac{1}{2} \frac{\partial C}{\partial z} {V}^{2} ,$$

where C is the capacitance between the electrodes and V is the applied voltage potential across the electrodes. For an ideal parallel-plate capacitor, capacitance equals:

$$C = \frac{ϵ A}{{g}_{0}} ,$$

where ε is the electrical permitivity of the dielectric (generally air) between the electrodes, A is the area of overlap of the electrodes, and g₀ is the initial gap length between the electrodes. Thus, the electrostatic force Fₑ is attractive and can be expressed as:

$${F}_{e} = \frac{1}{2} \frac{ϵ A}{{( {g}_{0} + z )}^{2}} {V}^{2} .$$

Upon application of the driving voltage, the flexible electrode will displace a distance delta z until the system again establishes equilibrium such that Fₑ=−Fₘ.

A shortcoming of electrostatic actuators of the type described above is that they are capable of only small actuations. Furthermore, at driving voltages above a threshold level, the electrostatic force between the electrodes becomes too strong and the flexible electrode collapses against the fixed electrode, a phenomenon referred to as “pull-in”. It has been analytically determined that, for an ideal parallel plate actuator, pull-in occurs at:

$$V > \sqrt{\frac{8 {kg}_{0}^{3}}{27 ϵ A}}$$

which corresponds to a displacement of:

$$z > \frac{1}{3} {g}_{0} .$$

Thus, where the voltage in the system shown in FIGS. 1 and 2 causes the flexible electrode to move greater than one-third of the initial gap length, electrode pull-in or capture occurs. This may result in destruction of the microactuator. At the very least, the system must be reset (by removing all or substantially all voltage from the electrodes) before the system is again able to perform its actuation function. While it is known to provide an additional capacitor in series with the above-described parallel plate electrostatic actuator to prevent electrode pull-in, the maximum displacement is in any event limited to the initial gap length, which must be kept relatively small, generally on the order of 1 to 10 microns (μm), to avoid having to use excessively large actuation voltages. In addition parallel plate capacitors are inherently nonlinear since their capacitance is inversely proportional to 1/z and the force is inversely proportional to 1/z². Although there are known methods that linearize these effects to a degree, nonlinearities can cause complications in feedback control, and position measurement when the parallel-plate capacitor is used as a sense capacitor.

Another type of electrostatic microactuator is a comb-finger actuator/sensor which is used to achieve/sense movement in a plane parallel to the chip in which it is formed, such as that described in Tang et al., U.S. Pat. No. 5,025,346, issued Jun. 18, 1991. Such a comb-finger actuator, shown schematically in FIG. 3 and represented by the circuit diagram of FIG. 4, includes a stationary comb 24 having a plurality of conductive comb-fingers 26, and a movable comb 28 having a plurality of conductive comb-fingers 30. The stationary and movable comb-fingers are interdigitated with each other so that upon application of a voltage potential V to the respective electrode fingers, an electrostatic actuation force Fₑ is generated. The force Fₑ is given by:

$${F}_{e} = n ϵ \frac{t}{g} {V}^{2} ,$$

where n is the number of fingers on the moving electrode, t is the thickness of the comb-fingers (i.e., along the Z-axis), and g is the gap between the moving and stationary fingers along the Y-axis. The fingers on the movable electrode move in the X-direction, into and out of the fingers on the fixed electrode to change the overlap of the fingers. It is also known to provide comb-finger actuators/sensors for achieving/detecting motion in a plane parallel to the chip where the movable fingers move perpendicularly to the length of the fingers, i.e., a movable finger moves in the Y-direction away from the fixed finger on a first side of the movable finger and toward the fixed finger on the opposite side of the movable finger. Such a microactuator is disclosed for example in Diem et al., U.S. Pat. No. 5,495,761, issued Mar. 5, 1996.

In addition to a non-linear response due to fringing effects on capacitance, conventional comb-finger microactuators as described above are only able to move in a plane parallel to the chip, and are thus ineffective for applications where forces and motion perpendicular to the chip surface are required.

Some prior-art references attempt to effect Z-axis comb-finger actuation by including a plurality of stationary and movable comb-fingers, with the movable comb-fingers being located above, i.e., at a higher Z-elevation, than the stationary comb-fingers. An example of such a microactuator is disclosed in Conant et al., “A Flat High-Frequency Scanning Micromirror,” 2000 Workshop for Solid State Sensors and Actuators (HH2000), Hilton Head Island, S.C., Jun. 4-8, 2000, pp. 6-9, Digest of Technical Papers. In this type of microactuator, applying a voltage potential between the top, movable fingers and the bottom, stationary fingers pulls the movable fingers down into overlapping interdigitation with the stationary fingers.

While such microactuators offer advantages of large actuation forces and distances, they are difficult and costly to manufacture. In addition, devices such as that described in Conant et. al. are particularly difficult to manufacture, because the stationary and movable comb-fingers are formed in different planes. In Conant et al., for example, the stationary fingers are conventionally etched in the upper surface of a first wafer. Subsequently, a second wafer is affixed to the upper surface of the first wafer, and the upper surface of the second wafer is polished and etched to form the movable fingers. It is critical during the formation of the movable fingers that they be precisely aligned with the stationary fingers in the layer below, as misalignment between the stationary and movable comb-fingers can lead to instability of the microactuator. However, as movable fingers are patterned in the top layer without knowing the precise position of the stationary fingers in the bottom layer buried below, it is difficult to achieve precise alignment of the respective stationary and movable fingers.

### SUMMARY OF THE INVENTION

It is therefore an advantage of the present invention to provide a microstructure capable of generating large electrostatic actuation forces in a direction perpendicular to the surface of the chip in which the microstructure is formed.

It is a further advantage of the present invention to provide a device having increased manufacturability.

It is another advantage of the present invention to provide well controlled linear or nonlinear actuation forces as a function of applied voltages.

It is a further advantage of the present invention to provide a microactuator capable of a large range of motion.

It is a still further advantage of the present invention to provide a microsensor capable of detecting displacements or relative position between two structural elements.

These and other advantages are provided by the present invention which in preferred embodiments relates to a micromachined device formed on a semiconductor chip on which an integrated circuit may be included. In preferred embodiments, the device may comprise a microactuator for exerting forces perpendicular to the surface of the chip, or a microsensor for sensing displacements perpendicular to the surface of the chip. The device includes one or more movable fingers interdigitated with one or more stationary fingers. In one embodiment used in an optical switching array, the device further includes a mirror coated onto a mirror base layer, and a spring anchored to the chip for flexibly supporting the mirror and movable fingers over the chip.

The device may be fabricated by etching the stationary fingers down into the upper surface of a semiconductor wafer formed of one or more layers of single crystal silicon. The movable fingers, and other device components such as the mirror base layer and spring mechanism are then etched down into the upper surface of the wafer. The device may alternatively be formed by a variety of other processing steps.

In order to create an electrostatic force between the stationary and movable fingers with the stationary and movable fingers being coplanar in an unbiased position, a voltage gradient is created preferably in the stationary fingers between a top portion distal from the wafer surface and a bottom portion proximate to the wafer surface. Thus, upon creation of the voltage gradient through the stationary fingers, and application of a voltage to the movable fingers, an electrostatic force is generated that causes movement of the movable fingers and associated components with respect to the stationary fingers. This movement may be precisely controlled by controlling the voltage potential within the stationary fingers, the voltage applied to the movable fingers, or a combination thereof.

### BRIEF DESCRIPTION OF THE DRAWINGS

The present invention will now be described with reference to the drawings in which:

FIG. 1 is a schematic representation of a prior art parallel plate microactuation system;

FIG. 2 is a circuit diagram of the prior art parallel plate microactuation system shown in FIG. 1;

FIG. 3 is a schematic representation of a prior art comb-finger microactuation system;

FIG. 4 is a circuit diagram of the prior art comb-finger microactuation system shown in FIG. 3; FIG. 5 is a schematic top view representation of a comb-finger microactuator in accordance with the present invention for actuating an advantage such as a mirror used in optical switching arrays;

FIG. 6 is a cross section of three stacked single crystal wafers forming a starting material from which a microactuator according to the present invention may be formed;

FIG. 7 is a cross section of three stacked single crystal wafers after forming filled trenches;

FIG. 8 is a cross section of three stacked single crystal wafers with the upper layer patterned to form movable fingers, a mirror base pad and a microspring mechanism;

FIG. 9 is a cross section of three stacked single crystal wafers with the sacrificial layer beneath the movable fingers, mirror base pad and microspring mechanism removed to release the microactuator;

FIG. 10 is a cross section of the three stacked single crystal wafers with the mirror base pad coated with a layer of gold to form a mirror;

FIG. 10b is a top view of an alternate embodiment of the invention;

FIG. 10c is a cross section of an alternate embodiment of the invention;

FIG. 11 is a schematic representation of a finger of the movable comb portion interdigitated with a pair of fingers of the stationary comb portion of the microactuator in accordance with the present invention;

FIG. 12 is a schematic top view representation of a comb-finger microactuator in accordance with an alternative embodiment of the present invention;

FIG. 13 is a schematic side view of the stationary and movable fingers for the embodiment of FIG. 12, showing the movement of the movable finger in phantom;

FIG. 14 is a schematic top view representation of a comb-finger microactuator in accordance with a further alternative embodiment of the present invention;

FIG. 15 is a schematic representation of movable and stationary fingers, and associated circuit, of the microsensor in accordance with the present invention; and

FIG. 16 is a schematic representation of movable and stationary fingers, and associated circuit, of the microsensor in accordance with an alternative embodiment of the present invention.

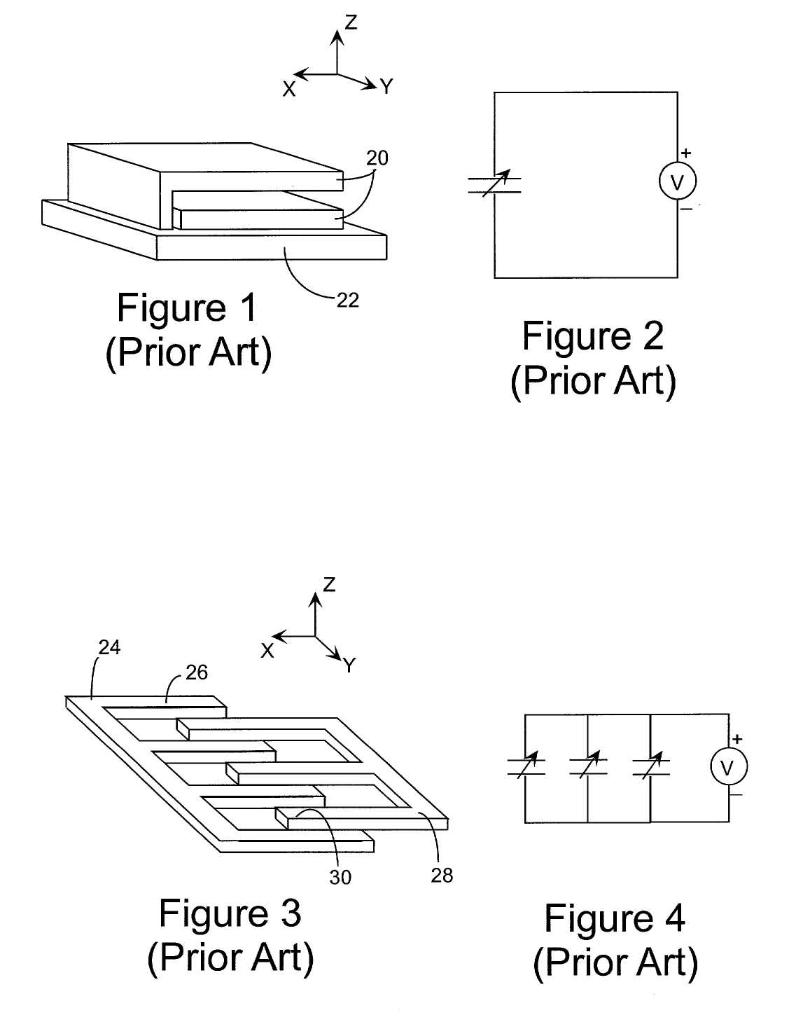

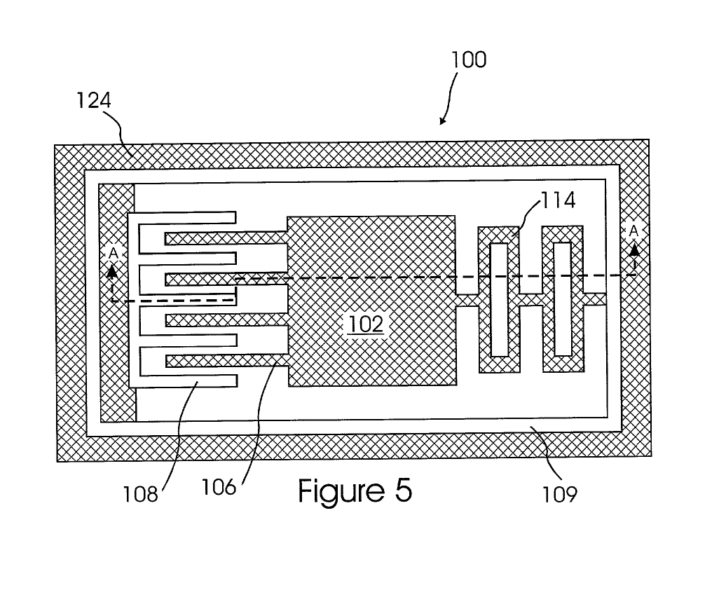

### DETAILED DESCRIPTION

Preferred embodiments of the present invention will now be described with respect to FIGS. 5-16, which relate to an easily fabricated comb-finger microactuator capable of producing linear or nonlinear actuation forces, or detecting displacements of a mechanical element, perpendicular to the chip in or on which the microactuator is formed, as a function of applied voltages. It is understood that the present invention is not limited to a comb-finger that operates in a fashion to provide a force, or detect a position, perpendicular to the surface of a chip. In alternative embodiments, the present invention may be used in applications in which displacement is effected or detected parallel to the surface of a substrate, or at any angle between 0 an 90 degrees from perpendicular. Such applications include optical gratings or microengines. The principles of the invention are the same independent of the direction of displacement relative to the surface of the chip.

A preferred embodiment of the invention is described hereinafter for actuating a mirror on a chip in an optical switching array. However, it is understood that the present invention may be used as a microactuator in a variety of other applications including optical beam steering, optical displays, disk drive head actuators and a wide variety of other medical and mechanical microactuation systems. Additionally, as explained in greater detail below, the concepts of the present invention may also be employed to provide a sensor for detecting minute movements of small objects.

Referring now to FIG. 5, there is shown a comb microactuator 100 for actuating a mirror 102. The mirror may be used for example as a bi-stable switch in an optical switching array. In such an embodiment, a light signal (not shown) is reflected off the mirror 102 to first and second receivers (not shown) depending on the position of the mirror. It is understood that the mirror may be actuated to and between greater than two positions to achieve a plurality of optical switching conditions.

The microactuator 100 includes a plurality of movable fingers 106 interdigitated with a plurality of stationary fingers 108, anchored to a substrate. It is understood that the number of movable and stationary fingers may vary in alternative embodiments, from the arrangement shown in FIG. 5. In alternative embodiments of the present invention, it is contemplated that there be two stationary fingers for each movable finger so that each movable finger is surrounded on both sides by a stationary finger. It is further contemplated that there be two movable fingers for each stationary finger so that each stationary finger is surrounded on both sides by movable fingers.

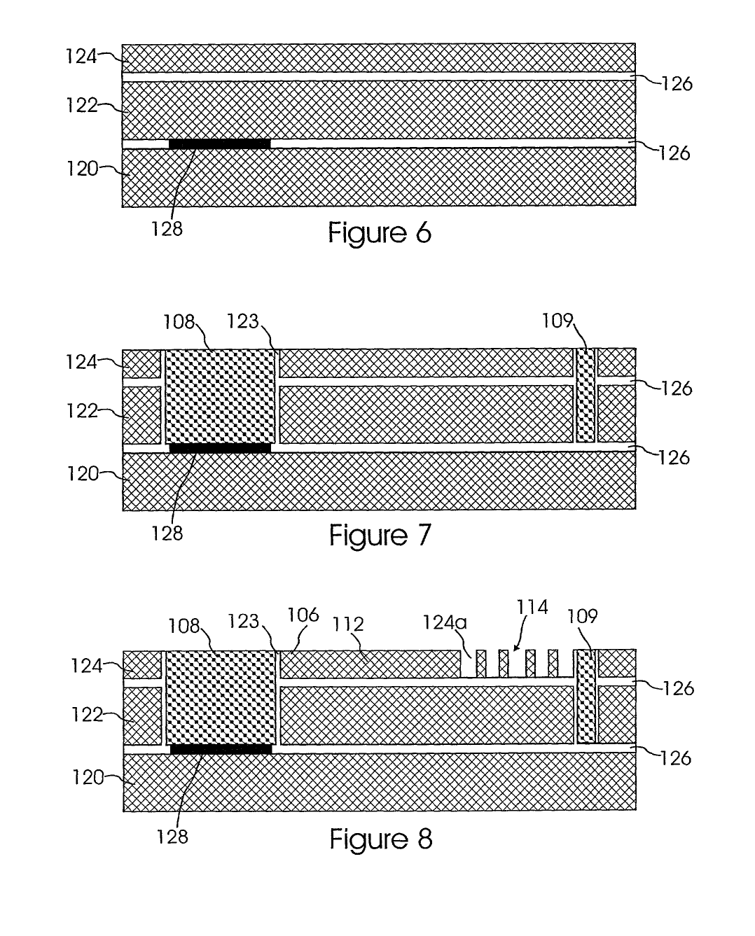

Those of skill in the art would appreciate that microactuator 100 may be fabricated by a number of fabrication methods. An example of one such fabrication method will now be explained in general with reference to FIGS. 6-10 and is based upon the method disclosed in U.S. Provisional Pat. Application Serial No. 60/222,751 to Brosnihan, T., and Judy, M., filed on Aug. 3, 2000, entitled “Bonded Wafer Optical MEMS Process” converted to a regular patent application on Aug. 3, 2001. This application is hereby incorporated in its entirety by reference. The views shown in FIGS. 6-10 are taken with respect to a cross-section through line A-A in FIG. 5 (taken through both the stationary and movable fingers). In one embodiment of the invention, the microactuator 100 is formed in three stacked layers of single crystal silicon wafers: a first handle layer 120, a sacrificial layer 122 and a device layer 124 as shown in FIG. 6. The layers may be separated by an insulator 126 such as silicon dioxide to electrically isolate the respective layers. A conductive contact 128, such as doped polysilicon, may be formed along a portion of the interface, between the handle layer and the sacrificial layer to provide electrical contact with the bottom of the stationary fingers as explained hereinafter. Conductive contact 128 may be isolated from one or more of layers 122, 120 by an additional layer of a dielectric, such as thermally grown or deposited silicon dioxide.

In a first fabrication step, layers 124 and 122 are anisotropically etched down to contact 128 in the shape of the stationary fingers 108 and surrounding trench 109. This etch comprises a first anisotropic silicon etch through silicon layer 124, a first anisotropic oxide etch through the top layer of oxide 126, and a second anisotropic etch through silicon layer 122. Contact 128 may comprise an additional silicon dioxide layer between 128 and 122 (such as a blanket-deposited layer of TEOS-oxide, not shown). In such an embodiment, the second anisotropic silicon etch may use the additional silicon dioxide layer as an etch-stop layer to stop vertical etching after etching through layer 122, since anisotropic silicon etches, and plasma etches in particular, typically may be made selective to silicon in comparison to silicon dioxide. This may be followed by a second anisotropic oxide etch to remove silicon dioxide to expose the surface of 128.

Next, the trench sidewalls are lined with an oxide layer 123. The oxide layer may be formed through, for example, a blanket TEOS deposition step followed by an anisotropic oxide etch to remove deposited oxide from the surface of layer 128. The etched space is then filled with polysilicon as shown in FIG. 7 to form stationary fingers 108 and surrounding trench 109. The polysilicon is preferably doped so as to be slightly conductive, highly conductive or somewhere in between.

Device layer 124 is then patterned in a conventional etch process, forming trenches 124a in layer 124 as shown in FIG. 8, to form the movable fingers 106, a mirror base layer 112 on which the mirror will be formed, and a microspring mechanism 114 (see FIG. 5) that allows flexing of the movable fingers and mirror base pad. Being able to visualize the stationary fingers in this layer allows precise mask alignment of the mask used to etch regions 124a to the defined stationary finger regions. While one embodiment of a microspring 114 is shown, those of skill in the art would appreciate that microspring 114 may have any of various known configurations.

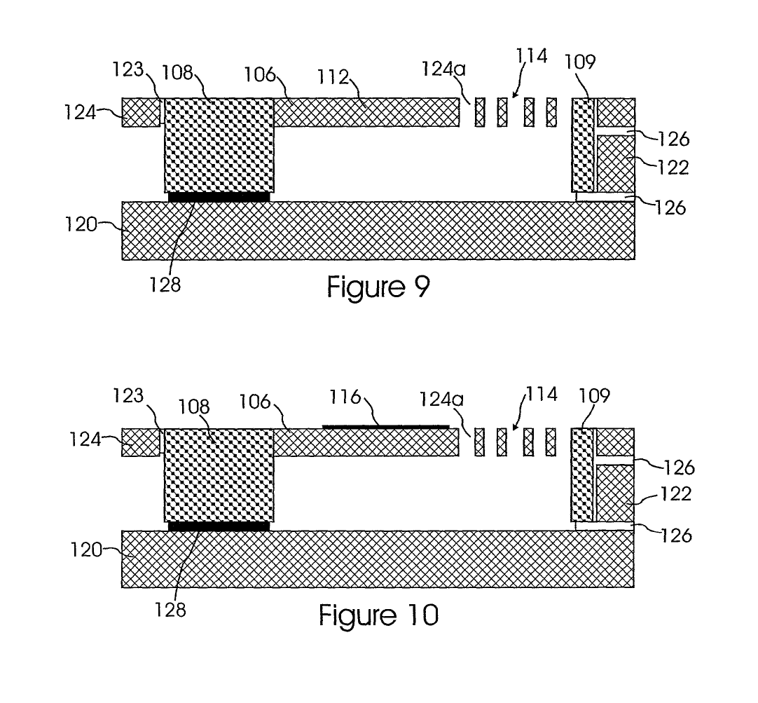

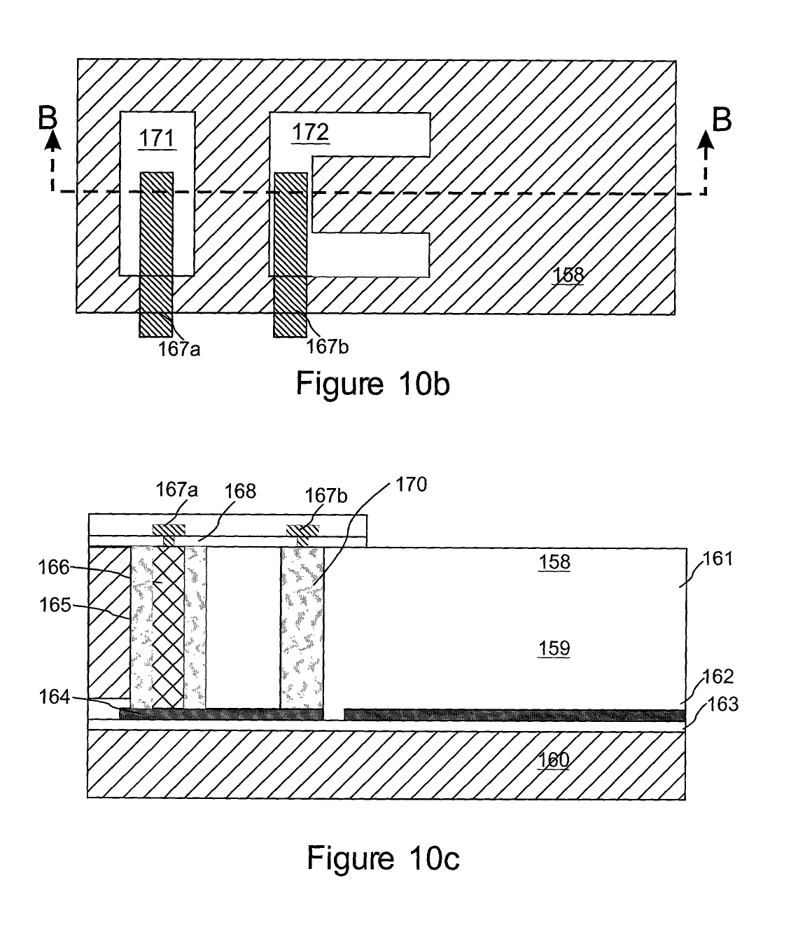

After layer 124 is etched, the remaining portions of layer 124 and 108 are protected with photoresist patterned to expose selected trenches 124a. Next, the portions of layer 126 in these selected regions is removed by a hydrofluoric-acid etching step, thereby exposing regions of sacrificial layer 122. Next, layer 122 beneath movable fingers 106, mirror base layer 112 and microspring mechanism 114 is etched away using a xenon difluoride etch at reduced atmospheric pressure or the like as shown in FIG. 9 to release the movable fingers, base layer and spring mechanism. Spring 114 is anchored to trench 109. A hydrofluoric acid etch may be used to remove oxide 126 from the bottom of layer 124 and the top of layer 120. Finally, a shadow mask 116 of gold is then coated onto the base layer to form the mirror as shown in FIG. 10.

Those of skill in the art would appreciate that microactuator 100 may be formed by a variety of other processing steps. In one such alternative embodiment, the movable fingers 106, base layer 112 and spring mechanism 114 may be formed prior to the formation of the stationary fingers 108.

An alternative embodiment includes both filled high- and low-resistivity trenches to enable a low-resistance contact to the bottom of high-resistance stationary fingers, the low-resistance contact being accessible from the top surface of the device layer. FIG. 10c shows a cross-section through line B-B in FIG. 10b, a lightly-doped stationary comb-finger 172 and a heavily doped contact 171 to the bottom of stationary comb finger 172. While a movable, interdigitated comb-finger is not shown in FIGS. 10b, 10c, construction of an interdigitated comb-finger follows the steps shown in FIGS. 8-10. In FIG. 10c, the starting material is similar to the starting material shown in FIG. 6, except in this embodiment, layer 164, comprising doped polysilicon, is patterned as well as isolated from layers 159 and 160 by two layers of deposited or grown silicon dioxide 162 and 163. Next, the trenches that define stationary comb-finger 172 and contact 171 are simultaneously formed during an anisotropic trench etch, as described above. A two-step deposition process is now performed: first a layer of undoped or lightly-doped polysilicon is deposited of sufficient thickness to form a filled trench 170. This polysilicon is also deposited on the sidewalls of contact 171, as denoted by 165. Next, a heavily-doped layer of polysilicon 166 is deposited to completely fill trench 171. The polysilicon may then be removed from the surface using a silicon etching step, for example a plasma etch. The conductivity is selected by the relative size of the trenches. Metal interconnects may be formed to contact the heavily doped and lightly doped trenches by depositing or growing a dielectric layer 168, such as deposited silicon dioxide, patterning and etching contact holes through this layer, depositing a layer of metal and patterning this metal to form interconnects 167a,b. Implantation and diffusion of an optional dopant at the top of trenches 170 allows ohmic contact between 167b and 170. Thus the stationary comb-finger 172 is electrically connected to at the top by metal interconnect 167b and at the bottom by metal interconnect 167a through trench 171 and polysilicon layer 164.

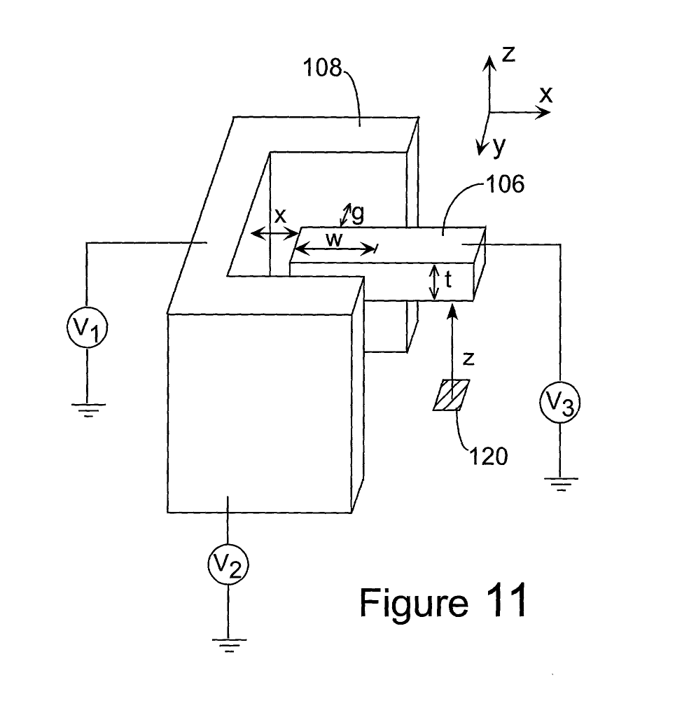

Actuation of the finished structure shown in FIGS. 5 and 10 will now be explained with reference to FIG. 11, which shows an enlarged perspective view of a movable finger 106 between a pair of adjacent stationary fingers 108. A first voltage, V₁, is applied to the top of the stationary fingers 108. This may be accomplished by metal contacts formed on the top surface of the polysilicon forming the stationary fingers, similar to that which may be formed by a substrate contact in a standard CMOS process (such as 167b shown in FIGS. 10b,c), or a wirebond.

A second voltage, V₂, is applied to the bottom of the stationary fingers 108. This may be accomplished by metal contacts formed on the bottom surface of the handle layer 120, or contacts 167a as shown in FIGS. 10b, 10c. In this embodiment, the voltage V₂ is transferred to the bottom surface of the stationary fingers via the contact 128 lying between and in electrical contact with the handle layer 120 and the bottom surface of the polysilicon forming the stationary fingers. In this way, a voltage gradient may be formed along the height of finger 108 by applying a voltage between the metal contact at the top surface and the bottom of the finger. Those of skill in the art would appreciate that the voltage V₂ may be applied to the stationary fingers by other methods.

The stationary comb-fingers 108 are doped to the extent of being partially conductive, preferably having a resistance between 0.5 Ohm-cm and 250 Ohm-cm, so that the voltage varies along the height, or thickness, of the stationary comb-fingers for different voltages V₁ and V₂. It is understood that the resistance of the stationary fingers 108 may be less than 0.5 Ohm-cm or greater than 250 Ohm-cm in alternative embodiments.

A bias voltage, V₃, is applied to the movable fingers 106 by means of an electrical contact formed to layer 124, typically located near or on the suspension. The movable fingers 106 may be lightly-doped or highly-doped, or somewhere in between, since the movable fingers are only capacitively coupled to the stationary fingers and there is no DC current flow between the stationary and movable fingers. Upon application of voltages V₁, V₂ and V₃, a voltage potential is established between the stationary and movable comb-fingers to thereby generate a force, F. The various voltages V₁, V₂ and V₃, as well as the configuration and relative orientation of the movable and stationary comb-fingers, control the amount of force, and direction of force, generated between the stationary and movable comb-fingers. Assuming a thickness, t₁, of the movable finger much less than the thickness, t₂, of the stationary finger, the force, F, may be approximately expressed as:

$$F = \frac{2 n {ϵ}_{0} wt}{g} [ ( \frac{( {V}_{2} - {V}_{3} ) ( {V}_{1} - {V}_{2} )}{{Z}_{max}} ) + {( \frac{{V}_{1} - {V}_{2}}{{Z}_{max}} )}^{2} z ] ,$$

where n is the number of movable fingers, ε is the permitivity of the space between the fingers, w is the length of overlap between the movable and stationary fingers, t is the thickness of the movable finger, g is the gap length between the stationary and moving fingers, Zₘₐₓ is the maximum displacement of the movable fingers, and z is the position of the movable finger relative to the bottom of the stationary finger. Some exemplary dimensions for the microactuator 100 are as follows:

n=10 to 50 movable comb-fingers;

w=a 5 μm to a 1000 μm overlap of the stationary and movable fingers;

t₁=2 μm to 50 μm;

t₂≧150% of t₁; and

g=1 μm to 25 μm.

The distance, x, on FIG. 11 is preferably a few times greater than the gap, g. Thus, the electrostatic force resulting from a capacitive coupling of the tip of the movable finger and the base of the stationary finger along the X-axis is minimal as compared to the electrostatic force, F, actuating the movable finger along the Z-axis. It is understood that the dimensions and relative spacings of the stationary and movable fingers may vary significantly beyond the ranges set forth above in alternative embodiments.

In an example having a positive voltage V₃, for a voltage V₁ less than V3 and greater than V₂, or for positive voltage V₁ less than V₃ and a negative voltage V₂, the movable comb-fingers will experience a pull down force toward the bottom of the stationary comb-fingers. On the other hand, in an example having a positive voltage V₃, for a voltage V₂ less than V3 and greater than V₁, or for positive voltage V₂ less than V₃ and a negative voltage V₁, the movable comb-fingers will experience a pull up force toward the top of the stationary comb-fingers.

Moreover, it can be seen from the above force equation that for a voltage V₃ much greater than V₁ and V₂, the resulting force is relatively independent of the position, z, of the movable comb-fingers between the stationary comb-fingers. Likewise, V₃ can be selected so as to be comparable to V₁ and V₂ so that the force generated is highly dependent on the position, z, of the movable fingers relative to the stationary fingers.

Some exemplary voltages to be applied to the microactuator 100 are:

V₁=−10 volts to +10 volts, and for example ±10 volts;

V₂=−5 volts to +5 volts and for example around 0 volts; and

V₃=−300 volts to +300 volts and for example around 100 volts.

It is understood that the voltages may vary significantly outside of the exemplary values set forth above in alternative embodiments.

It is clear from the above discussion that the force magnitude and polarity may be modulated by varying the voltage gradient set up by V1-V2, the movable finger potential V3, or a combination thereof.

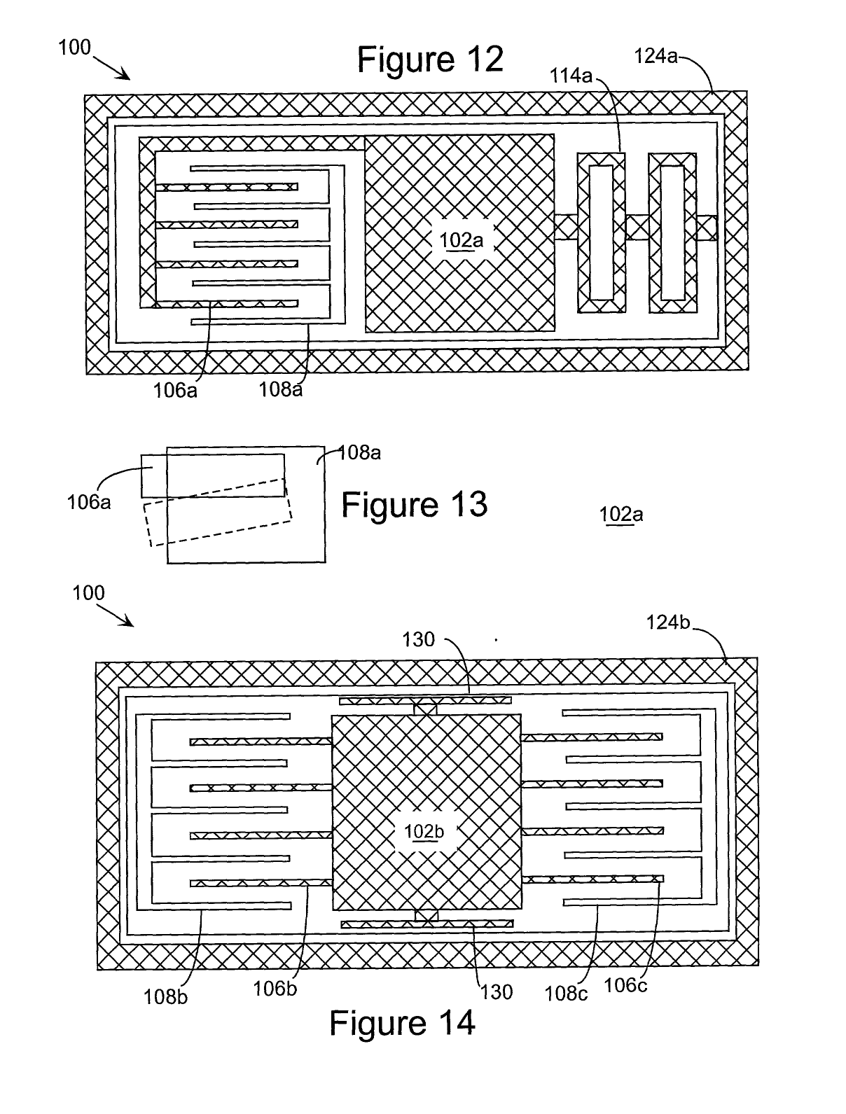

In the alternative embodiment of microactuator 100 shown in FIGS. 12 and 13, the positions of the movable fingers 106a and stationary fingers 108a relative to the mirror 102a have been reversed. The principle of operation is similar to that described above. However, upon pull down actuation of the movable fingers 106a relative to the stationary fingers 108a as shown in phantom in FIG. 13, the slight rotation of the movable fingers increases the area of overlap between the stationary and movable fingers, thereby increasing the actuation force.

In a further alternative embodiment shown in FIG. 14, the mirror 102b is formed on layer 124b and pivotally supported by a pair of torsional spring mechanisms 130. In this embodiment, a pair of microactuators 100 may be positioned on either side of the mirror so as to pivot the mirror either clockwise or counterclockwise, thus allowing the mirror to occupy three or more steady state positions (ie., unbiased, rotated clockwise, and rotated counterclockwise).

Those of skill in the art would further appreciate that the mirror may be mounted for pivoting about two perpendicular axes parallel to the sides of mirror 102. In such an embodiment, a microactuator 100 may be located along two adjacent sides of the mirror to actuate the mirror along the two perpendicular axes. Such a two-axis mirror may also be surrounded on four sides by a microactuator 100 in accordance with the present invention to provide at least five steady state positions (i.e., unbiased, clockwise and counterclockwise about the first axis, and clockwise and counterclockwise about the second axis).

The thicker finger (e.g., finger 108 in FIG. 11) has been described as being stationary and the thinner finger (e.g., finger 106 in FIG. 11) has been described as being movable. However, those of skill in the art would appreciate in view of the above disclosure that the device 100 may be formed so that the thicker finger 108 may be movable and the thinner finger 106 may be fixedly anchored to the substrate. In this embodiment, the mirror 102 would be affixed to the finger 108.

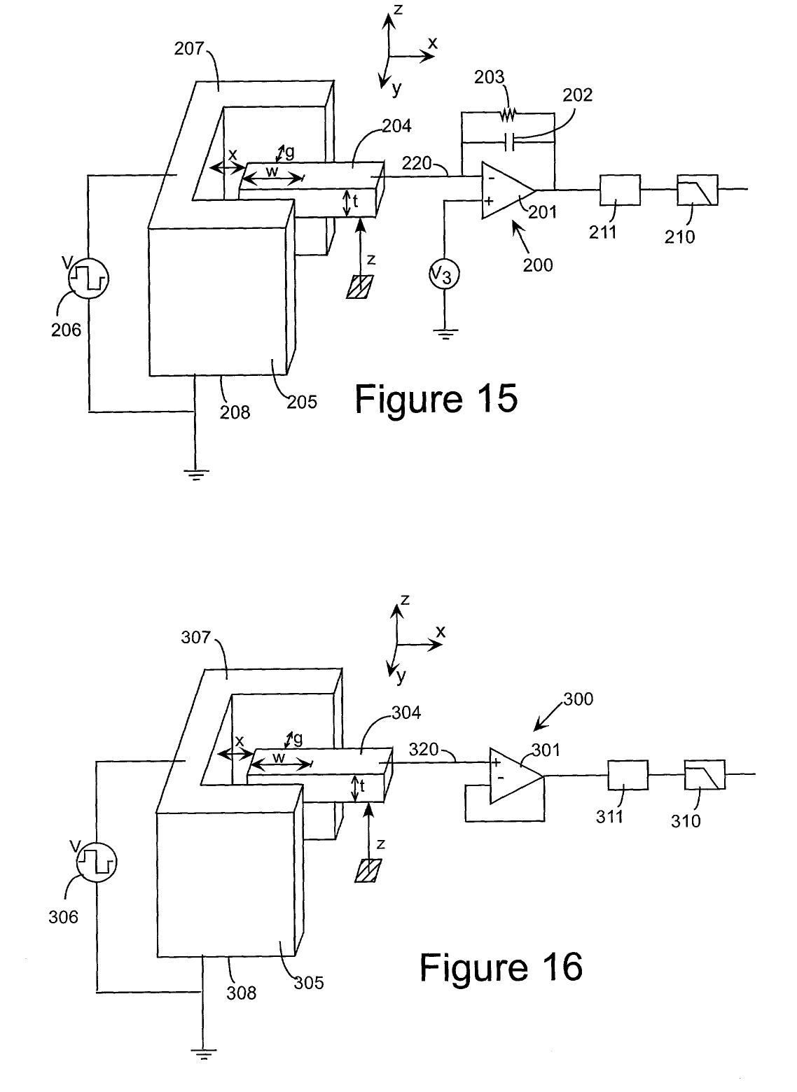

Up to this point, the micromachined device according to the present invention has been described primarily as a microactuator for generating controlled actuation forces upon application of voltages to the device. However, the micromachined device of the present invention may also comprise a microsensor for sensing displacements due to forces or accelerations. Two embodiments in which the invention is used as a displacement detector are showed in FIGS. 15 and 16. In FIG. 15, movable comb-finger 204 is connected to an op-amp circuit 200 configured as a leaky charge integrator. In particular, the comb-finger 204 is connected to the negative terminal 220 of an op-amp 201. The positive terminal of op-amp 201 is held at V₃, causing the feedback loop comprising charge integration capacitor 202 and optional dc stabilization resistor 203 to drive the negative op-amp terminal 220 to a potential equal to V₃. The RC time-constant of the integrator may be chosen such that the zero in the charge-input-to-voltage-output transfer function is several times lower than the modulation frequency to avoid attenuation or loss of signal. Alternatively, well-known switched capacitor techniques may be used to effect a resistor.

Displacement or position of the interdigitated, movable comb-finger 204 may be inferred by applying a modulation, or carrier, voltage across the stationary comb-finger 205, integrating the resulting charge by op-amp circuit 200, and demodulating the output of the op-amp circuit with demodulator 211, such as a chopper or a multiplier synchronous with the modulation voltage. Optional low-pass filter 210 may follow demodulation to filter spurious signals from the output. In this embodiment, the modulation voltage is applied by square-wave generator 206 connected between the top 207 and bottom 208 of stationary comb-finger 205. Typical values of the modulation voltage are 1 to 20V p-p at frequencies from 1 kHz to 1 MHz.

The modulation voltage sets up a time-varying voltage gradient along the thickness of the comb-finger which has the effect of modulating the charge integrated by the op-amp circuit. For example, if movable finger 204 is located near the top of stationary finger 205, the output of circuit 200 will have a large magnitude, as compared to when the movable finger is located near bottom terminal 208. The variation in output is principally due to the variation of the carrier magnitude at the position that the movable finger is located; the full magnitude appears at the top and zero magnitude appears at the bottom, since the bottom, in this embodiment, is grounded. Note that this device behaves quite differently from prior-art MEMS capacitance-based displacement detection mechanisms, in that this device works even in when there is no change in the value of capacitance between movable and stationary comb-fingers.

In another embodiment of the invention, the bottom terminal may be driven by an anti-phase voltage, as opposed to held at ground with respect to terminal 207, resulting in a zero position-sense output when the movable finger is located approximately midway between the top and the bottom of the stationary comb-finger. In this embodiment, the output will have approximately equal magnitude, but opposite sign, at the top-most and bottom-most positions.

A further embodiment includes one or more controllable voltage sources connected between terminals 208 and 207 to allow quasi-DC or low-frequency forces to be applied to the movable comb-finger while simultaneously using the interdigitated comb-finger pair for position measurement. Note that since the movable finger is driven to V₃ by op-amp circuit 200, one can apply feedback force while measuring position from the same comb-fingers, since the feedback and position sensing functions are frequency multiplexed; feedback force voltages are applied by the additional controllable voltage sources at low frequencies or around dc, while the position sensing signals are detected around the modulation frequency. The effect of forces induced by the high-frequency sense-modulation voltages on the movable finger is substantially removed by the low-pass filter effect from the inertia of the movable finger. The effect of the slow-changing feedback voltage on the output of the position sensing interface is modulated to the carrier frequency and substantially removed by the optional low-pass filter 210 during the position-sense demodulation process. Frequency-modulation techniques for separating forcing and sensing operations are well known by those skilled in the art. Alternatively well known switched capacitor techniques may be used to perform position sensing and force feedback using time multiplexing of capacitor function.

In yet another embodiment of the invention shown in FIG. 16, a voltage buffer is used to detect displacement or position of the interdigitated, movable comb-finger 304 in response to a modulation voltage applied by a square-wave generator 306 between the top 307 and bottom 308 terminals of stationary comb-finger 305. Operation of this embodiment is similar to the embodiment shown in FIG. 15, except in this case the charge created in response to the modulation voltage appears as a voltage on node 320, the input to the op-amp circuit 300, the voltage being dependent on the total unbootstrapped capacitance at this node. Bootstrapping and capacitive-sensing using voltage buffering are well known techniques by those skilled in the art.

Although the invention has been described in detail herein, it should be understood that the invention is not limited to the embodiments herein disclosed. For example, the stationary comb-finger could be formed of a thin, resistive material, such as silicon-chromium, or nickel-chromium deposited over an insulating core of a dielectric, such as silicon dioxide; the invention may alternatively comprise one or more stationary and movable plates that effect fingers or other geometries other than the rectilinear comb-fingers shown; the invention may provide actuation of displacement detection along or about an axis which is not substantially perpendicular to the surface of the substrate to which the stationary fingers are attached; two or more sets of interdigitated comb-fingers may be combined with a differential op-amp circuit for a differential position-sense interface. Further, various changes, substitutions and modifications may be made to the disclosure by those skilled in the art without departing from the spirit or scope of the invention as described and defined by the appended claims.

I claim:

1. A microstructure, comprising:
a first finger including a length, a first surface and a second surface, said first finger capable of supporting a voltage potential between said first and second surfaces; and
a second finger capable of moving with respect to said first finger between said first and second surfaces upon application of a voltage to said second finger.

2. A microstructure as recited in claim 1, further comprising a first voltage source for supplying a voltage to said first surface of said first finger.

3. A microstructure as recited in claim 2, further comprising a second voltage source for supplying a voltage to said second surface of said first finger.

4. A microstructure as recited in claim 3, further comprising a third voltage source for supplying a voltage to said second finger.

5. A microstructure as recited in claim 4, wherein the magnitude of said voltage supplied by said third voltage source is significantly greater than said voltage supplied by said first and second voltage sources.

6. A microstructure as recited in claim 4, wherein the magnitude of said voltage supplied by said third voltage source is at least ten times greater than said voltage supplied by said first and second voltage sources.

7. A microstructure as recited in claim 4, wherein said microstucture effects a force transducer upon said first finger.

8. A microstructure as recited in claim 4, wherein said microstucture effects a force transducer upon said second finger.

9. A microstructure as recited in claim 1, said microstructure further comprising an output, said output connected to an opamp circuit having an output, wherein said opamp circuit output provides a signal representative of the relative position between said first and second fingers.

10. A microactuator formed on a substantially planar substrate capable generating an electrostatic force in a direction substantially perpendicular to said substrate, said microactuator comprising:
a stationary comb-finger including a top portion relatively distal from the substrate and a bottom portion relatively proximal to the substrate, said stationary comb-finger capable of supporting a voltage potential between said top and bottom portions; and
a movable comb-finger capable of moving with respect to said stationary comb-finger between said top and bottom portions upon application of a voltage to said movable comb-finger.

11. A microactuator as recited in claim 10, further comprising at least a first voltage source coupled between said top and bottom portions of said stationary finger, and a second voltage source coupled to said movable finger.

12. A microactuator as recited in claim 11, wherein the magnitude of said voltage supplied by said second voltage source is significantly greater than said voltage supplied by said at least first voltage source.

13. A microactuator as recited in claim 11, wherein said voltage supplied by said second voltage source is approximately 100 volts and said voltage supplied by said at least first voltage source is approximately 10 volts.

14. A comb-finger microactuator as recited in claim 10, a dimension of said stationary finger in a direction perpendicular to the substrate being greater than a dimension of said movable finger in a direction perpendicular to the substrate.

15. A microactuator as recited in claim 10, a dimension of said stationary finger in a direction perpendicular to the substrate being at least one and one-half times greater than a dimension of said movable finger in a direction perpendicular to the substrate.

16. A comb-finger microactuator formed on a substantially planar substrate capable generating an electrostatic force in a direction substantially perpendicular to said substrate, the comb-finger microactuator comprising:
a stationary comb-finger including an upper surface lying in a plane substantially parallel to said substrate; and
a movable comb-finger including an upper surface lying in said plane in an unbiased position, said movable comb-finger capable of moving with respect to said stationary comb-finger in a plane substantially perpendicular to said substrate upon application of at least a first voltage to said stationary comb-finger and a second voltage to said movable comb-finger.

17. A microsensor formed on a substantially planar substrate comprising:
a stationary finger including a top portion and a bottom portion, said stationary finger capable of supporting a voltage potential between said top and bottom portions;
a movable finger capable of moving with respect to said stationary finger between said top and bottom portions;
at least one modulation voltage source connected between said top and bottom portions of said stationary finger; and
a circuit connected to said movable finger, said circuit including an output responsive to a change in position between said movable and stationary fingers

18. A microsensor as recited in claim 17, wherein said circuit includes an op-amp configured as a voltage buffer.

19. A microsensor as recited in claim 17, wherein said circuit includes an op-amp and a charge integration capacitor, wherein said circuit forms a charge integrator.

20. A microsensor as recited in claim 17, further including a demodulation circuit.

21. A microsensor as recited in claim 20, further including a low-pass filter.

22. A microsensor as recited in claim 20, wherein said modulation voltage and demodulation circuit operate continuously.

23. A microsensor as recited in claim 20, wherein said modulation voltage and demodulation circuit operate as a sampled-data system.

24. A microsensor as recited in claim 17, further including at least one feedback voltage source coupled between said top and bottom portions of said stationary comb-finger.

25. A microsensor as recited in claim 17, wherein said output responsive to said change in position is frequency multiplexed.

26. A microsensor as recited in claim 17, wherein said output responsive to said change in position is time multiplexed.

27. An assembly for an optical switching array micromachined in a substrate, the assembly comprising:
a mirror for reflecting a signal to one of at least a first and second positions;
a spring member affixed to said mirror for flexibly anchoring said mirror over said substrate;
a microactuator for moving said mirror between said at least first and second position, said microactuator including:
a stationary comb-finger having a top portion relatively distal from the substrate and a bottom portion relatively proximal to the substrate, said stationary comb-finger capable of supporting a voltage potential between said top and bottom portions; and
a movable comb-finger attached to said mirror, said movable comb-finger and said mirror moving with respect to said substrate in a direction substantially perpendicular to said substrate upon application of a voltage to said movable comb-finger and said stationary comb-finger.

28. An assembly for an optical switching array as recited in claim 27, wherein said movable fingers are offset approximately 180° from said spring mechanism with respect to a center of said mirror.

29. An assembly for an optical switching array as recited in claim 27, further including a second set of movable and stationary fingers wherein said second set of movable and stationary fingers are offset approximately 90° from the first set of movable and stationary fingers.
